(19) United States
(12) Patent Application Publication
(10) Pub. No.: US 2002/0121476 A1
(43) Pub. Date: Sep. 5, 2002

(54) Scraping apparatus and method thereof

(76) Inventor: Philemon Wang, Taipei (TW)

Correspondence Address: BRUCE H. TROXELL, SUITE 1404, 5205 LEESBURG PIKE, FALLS CHURCH, VA, 22041, US

(21) Appl. No.: 10/080,545

(22) Filed: Feb. 25, 2002

(30) Foreign Application Priority Data
Mar. 2, 2001 (TW) 090104814

(51) Int. Cl. B01D 21/18

(52) U.S. Cl. 210/527

(57) ABSTRACT

A mud/sediment scraping apparatus comprises a first scraping assembly including scraping members and a second scraping assembly including scraping members alternate with that of the first scraping assembly. A scraping method comprises activating scraping assemblies to move toward each other at a first phase of a cycle of a reciprocating motions thereof, move away from each other at a next second phase, and move toward each other at a next third phase in scraping mud/sediment settled on bottom of pond.

### BACKGROUND OF THE INVENTION

1. Field of the Invention

The present invention relates to scraper and more particularly to an improved scraping apparatus and method thereof capable of effectively removing mud/sediment from pond.

2. Description of Related Art

Conventionally, scrapers are classified as sprocket-operated or reciprocating ones. The former ones are disadvantageous for being expensive, difficult to operate, and bulky nearly occupied the whole pond. As to operation of the latter ones, it may be best illustrated in FIGS. 21 to 25. As shown, a scraping assembly of a reciprocating scraper comprises parallel scraping members A, B, C, and D each having an inclined plane (i.e., scraping side) a. In FIG. 21, scraping assembly is not activated while sand 2 is depositing. Scraping members B, C and D will move forward from positions shown in FIG. 21 to that shown in FIG. 22 (i.e., moving rightward as viewed in FIGS. 21 to 25) for scraping mud/sediment 4 lain on bottom of pond 3. This scraping movement will continue until stopped in position shown in FIG. 23. At this time, original mud/sediment 4 shown in FIG. 22 has been pushed to one (i.e., pushed mud/sediment 5) shown in FIG. 23. Thereafter, scraping assembly moves backward from the position shown in FIG. 23 to that shown in FIG. 24. In FIG. 24, portion of mud/sediment 6 of the pushed mud/sediment 5 slides over inclined plane a of each of scraping members A, B and C. This backward movement will continue until stopped in position shown in FIG. 25. This completes a cycle of a series of continuous, reciprocating movements of the scraper.

However, the prior art suffered from several disadvantages. For example, portion of mud/sediment 6 is slid over inclined plane a of scraping member. This means that this portion of mud/sediment 6 is not removed. Further, a certain portion of the remaining pushed mud/sediment 5 is pushed back in the backward movement of scraper. Hence, the effective amount of mud/sediment being removed in a single scraping movement (i.e., a cycle) is a subtraction of above two portions from the pushed mud/sediment 5. Thus, its efficiency is not high. In addition, stroke of hydraulic cylinder of the scraper is required to be large because stroke of scraping assembly is required to be larger than spacing of two adjacent scraping members. Typically, for example, stroke of scraping assembly is about 70 cm and spacing of two adjacent scraping members is about 50 cm. In other words, in operation scraping member A is required to move to a position more than about 20 cm passed the initial position of scraping member B. Otherwise, the mud/sediment scraping effect is neutralized. This means that as stated above, stroke of hydraulic cylinder of the scraper is required to be large in design. This has the drawbacks of high manufacturing cost, more rigid components due to longer links, and complex linking mechanisms. Moreover, the number of scraping members is limited because stroke of scraping assembly is required to be larger than spacing of two adjacent scraping members. Thus, it is desirable to provide a novel scraping apparatus and method thereof in order to overcome the above drawbacks of prior art.

### SUMMARY OF THE INVENTION

It is an object of the present invention to provide a mud/sediment scraping apparatus comprising a first scraping assembly including a plurality of scraping members, a plurality of first connecting members, and a plurality of first shafts wherein each scraping member is activatable by operating the first connecting member and the first shaft a second scraping assembly including a plurality of scraping members, a plurality of second connecting members, and a plurality of second shafts wherein each scraping member is activatable by operating the second connecting member and the second shaft; and a transmission assembly for driving the scraping assemblies; wherein the scraping assemblies move toward each other at a first phase of a cycle of reciprocating motions thereof, move away from each other at a next second phase of the cycle of the reciprocating motions thereof, and move toward each other at a next third phase of the cycle of the reciprocating motions thereof in scraping mud/sediment settled on bottom of a pond.

It is another object of the present invention to provide a mud/sediment scraping method comprising arranging a plurality of parallel scraping members wherein the odd-numbered scraping members belonging to a first scraping assembly are alternate with the even-numbered scraping members belonging to a second scraping assembly; defining a spacing between any two adjacent scraping members as S, a stroke of the scraping member of the first scraping assembly as L1, and a stroke of the scraping member of the second scraping assembly as L2 wherein relations of L1<<S and L2<<S hold; and defining a gap between two adjacent scraping members belonging to different scraping assemblies as K for preventing contact from occurring in reciprocating motions of the scraping assemblies wherein the scraping assemblies move toward each other at a first phase of a cycle of the reciprocating motions thereof, move away from each other at a next second phase of the cycle of the reciprocating motions thereof, and move toward each other at a next third phase of the cycle of the reciprocating motions thereof during mud/sediment scraping.

By utilizing this scraping apparatus and method thereof, as compared with the prior art a number of advantages are obtained. For example, stroke of hydraulic cylinder of the apparatus is shorter, manufacturing cost is reduced, less rigid components, simple linking mechanisms, and most importantly the number of scraping members is reduced due to higher scraping efficiency.

The above and other objects, features and advantages of the present invention will become apparent from the following detailed description taken with the accompanying drawings.

### BRIEF DESCRIPTION OF THE DRAWINGS

FIG. 1 is a cross-sectional view of a scraper according to the invention in an inoperative state;

FIG. 2 is a view similar to FIG. 1 showing stroke of scraping assembly and spacing of two adjacent scraping members;

FIG. 3 is a view similar to FIG. 1 showing second scraping assembly moving forward while first scraping assembly moving backward;

FIG. 4 is a view similar to FIG. 1 showing first scraping assembly moving forward while second scraping assembly moving backward;

FIG. 5 is a cross-sectional view showing scraping members of the scraper in inoperative states while sand is depositing;

FIG. 6 is a cross-sectional view showing first scraping assembly moving forward while second scraping assembly moving backward both from initial positions for scraping mud;

FIG. 7 is a view similar to FIG. 6 showing second scraping assembly moving forward while first scraping assembly moving backward;

FIG. 8 is a view similar to FIG. 6 showing first scraping assembly moving forward while second scraping assembly moving backward;

FIG. 9 is a perspective view showing an arrangement of scraping members of scraping assemblies in an inoperative state;

FIG. 10 is view similar to FIG. 9 showing first scraping assembly moving forward while second scraping assembly moving backward;

FIG. 11 is view similar to FIG. 9 showing second scraping assembly moving forward while first scraping assembly moving backward;

FIG. 12 is a cross-sectional view of transmission assembly installed at a rear end of pond;

FIG. 12A is a cross-sectional view of transmission assembly installed at a front end of pond;

FIG. 13 is a cross-sectional view of limiting assembly installed at a rear end of pond;

FIG. 13A is a cross-sectional view of limiting assembly installed at a front end of pond;

FIG. 14 is another cross-sectional view of limiting assembly installed at a rear end of pond;

FIG. 14A is another cross-sectional view of limiting assembly installed at a front end of pond;

FIG. 14B is a cross-sectional view showing connecting member having an adjustment hole;

FIG. 15 is a cross-sectional view of a first preferred embodiment of rail assembly according to the invention;

FIG. 16 is a cross-sectional view of a second preferred embodiment of rail assembly according to the invention;

FIG. 17 is a cross-sectional view showing a second preferred embodiment of scraping member according to the invention;

FIG. 17A is a view similar to FIG. 17 showing an operation of scraping members;

FIGS. 18 and 19 are cross-sectional views showing third and fourth preferred embodiments of scraping member according to the invention respectively;

FIG. 20 is an exploded view of a second preferred embodiment of scraper according to the invention;

FIG. 20A is a schematic perspective view of the FIG. 20 scraper;

FIG. 21 is a cross-sectional view of scraping members of a conventional scraper; and

FIGS. 22 to 25 are cross-sectional views showing operating steps of the scraper of FIG. 21.

### DETAILED DESCRIPTION OF THE PREFERRED EMBODIMENTS

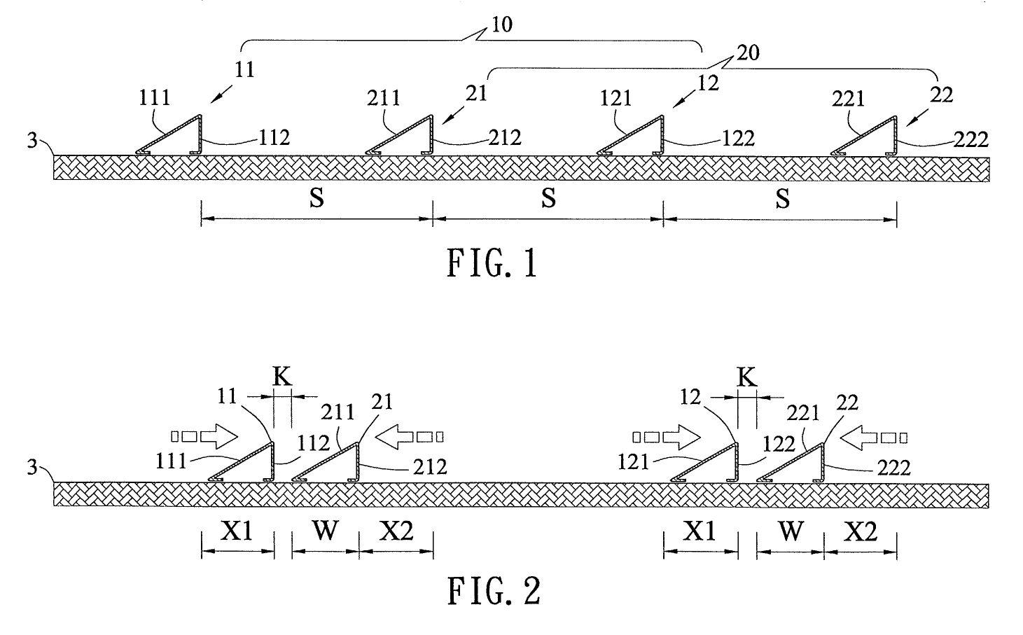

Referring to FIGS. 1 and 2, there is shown a scraper constructed in accordance with the invention. The scraper comprises a first scraping assembly 10 including parallel scraping members 11, 12, etc.; and a second scraping assembly 20 including parallel scraping members 21, 22, etc. wherein scraping members of first and second scraping assemblies 10 and 20 are alternate and a spacing S between any two adjacent scraping members is the same. Each of scraping members, for example, scraping member 11 has a scraping side 111 and a pushing side 112. X1 is defined as an initial forward stroke of a scraping member (e.g., scraping member 11) of first scraping assembly 10. X2 is defined as an initial backward stroke of scraping member (e.g., scraping member 21) of second scraping assembly 20. W is defined as a width of each scraping member. K is defined as a safe gap between two adjacent scraping members belonging to different scraping assemblies for preventing contact from occurring in reciprocating motion of the scraper. Note that a value of the gap K is selected from a plurality of reference values in design. Hence, a relation among these parameters is represented by equation 1 below:

X1+X2+W+K=S (1)

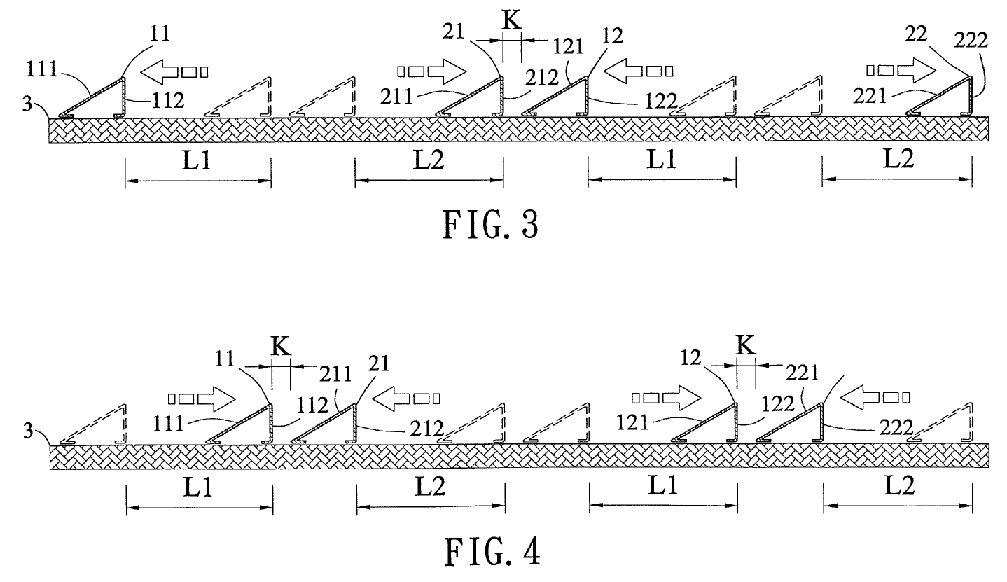

Referring to FIGS. 3 and 4, the back and forth movement of scraper will now be described below. L2 is defined as a stroke of scraping member of second scraping assembly 20. L1 is defined as a stroke of scraping member of first scraping assembly 10. Also, L1=2×X1 and L2=2×X2. Now in one case that L1 is equal to L2. That is, L1=X2 and X1=X2. Thus, X1+X2+W+K=L1+W+K=S. Hence, relations of L1<<S and L2<<S hold in the invention. Even in the other case that L1≠L2 and X1≠X2 above relations of L1<<S and L2<<S still hold since W is not zero.

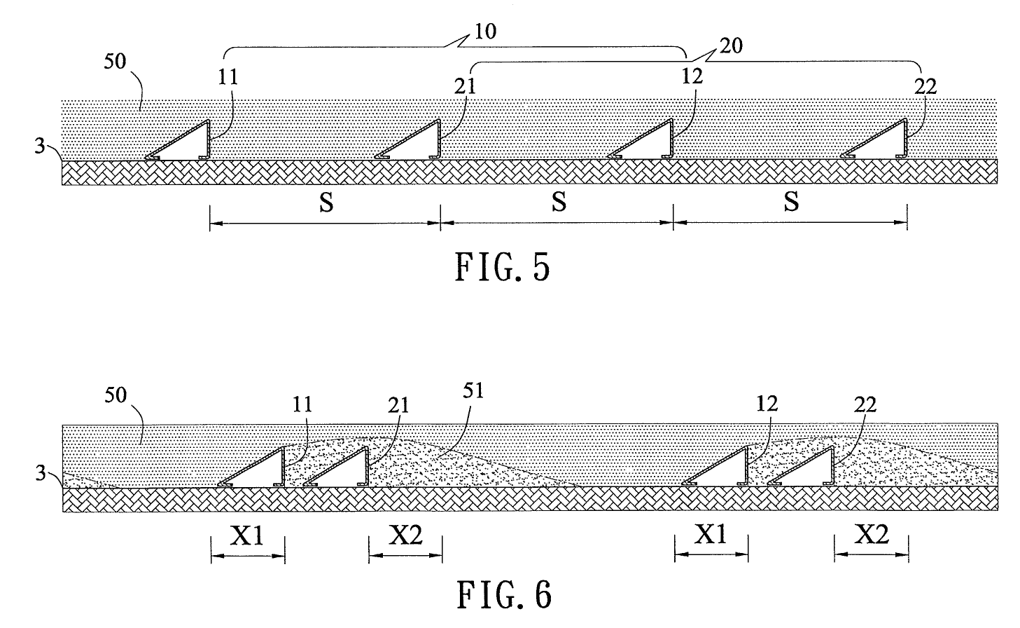

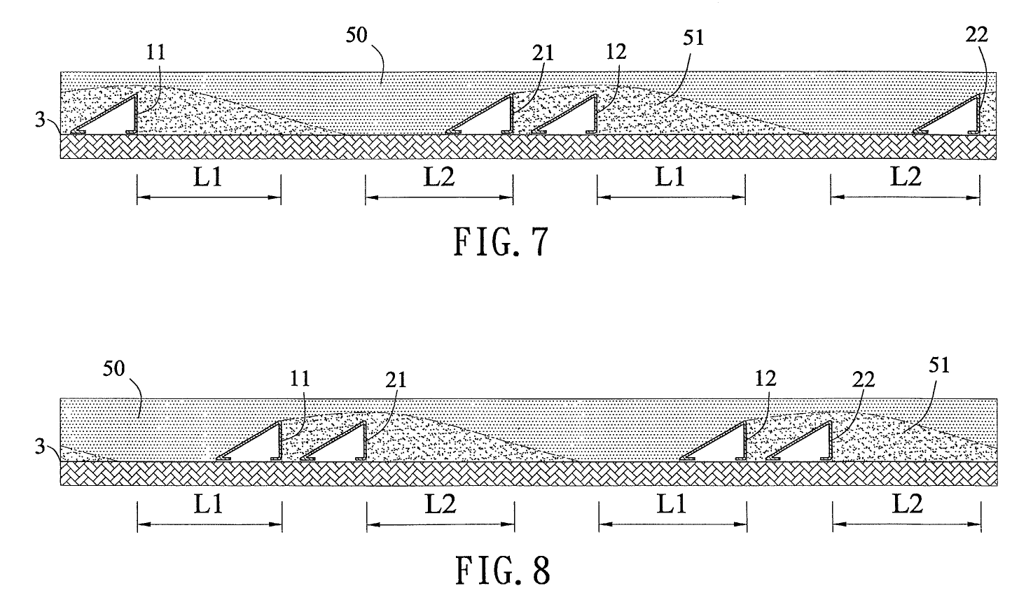

Referring to FIGS. 5 to 8, an operation of the scraper will now be described below wherein sand 50 is depositing. In scraping sand 50, scraping members II and 12 of first scraping assembly 10 move forward and scraping members 21 and 22 of second scraping assembly 20 move backward from positions shown in FIG. 5 to that shown in FIG. 6 respectively. It is seen that mud/sediment 51 is pushed to move over scraping member 21 by the scraping of two approaching scraping members 11 and 21, i.e., mud/sediment 51 moves forward. Thereafter, second scraping assembly 20 moves forward and first scraping assembly 10 moves backward from the positions shown in FIG. 6 to that shown in FIG. 7 respectively. Also, the pushed mud/sediment 51 continues to pass scraping member 12 to move forward by the scraping of two approaching scraping members 12 and 21. Thereafter, first scraping assembly 10 moves forward and second scraping assembly 20 moves backward from the positions shown in FIG. 7 to that shown in FIG. 8 respectively. Also, the pushed mud/sediment 51 continues to pass scraping member 12 to move forward by the scraping of two approaching scraping members 12 and 22. This completes a cycle of a series of continuous, reciprocating movements of the scraper. It is seen that mud/sediment pushing and scraping are performed in each cycle of scraping assemblies 10 and 20. Hence, mud/sediment 51 can be effectively pushed forward to a desired position.

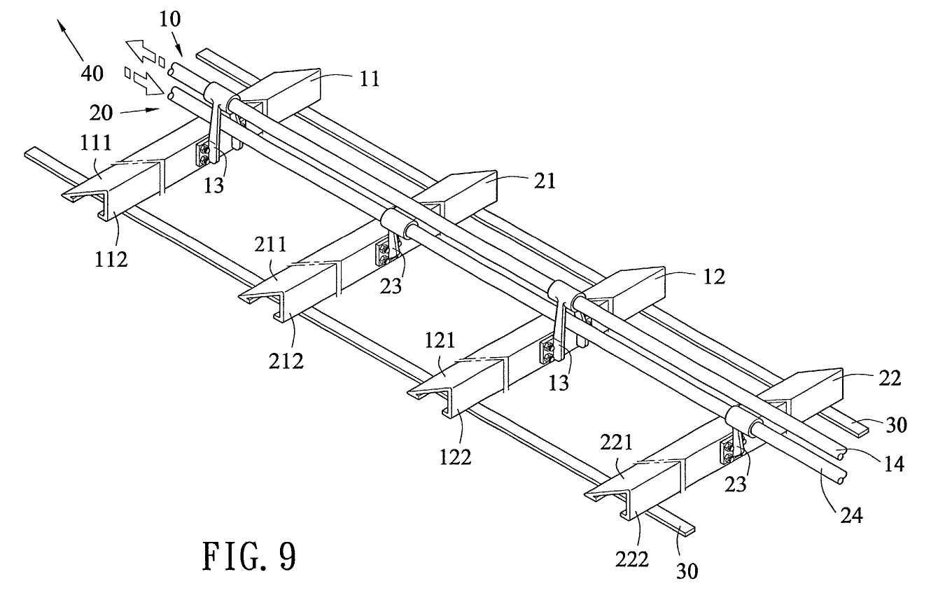

Referring to FIGS. 9 to 11, a complete construction of the scraper will now be described. The scraper comprises a first scraping assembly 10 including a plurality of scraping members 11, 12, etc., a plurality of first connecting members 13 and first shafts 14 wherein each scraping member (e.g., scraping member 11) is activatable by operating first connecting member 13 and first shaft 14 and each scraping member (e.g., scraping member 11) has a scraping side 111 and a pushing side 112; and a second scraping assembly 20 including a plurality of scraping members 21, 22, etc., a plurality of second connecting members 23 and second shafts 24 wherein each scraping member (e.g., scraping member 21) is activatable by operating second connecting member 23 and second shaft 24 and each scraping member (e.g., scraping member 21) has a scraping side 211 and a pushing side 212. As stated above, scraping members of first and second scraping assemblies 10 and 20 are alternate and a spacing S between any two adjacent scraping members is the same. Scraper further comprises a pair of rails 30 on bottom of pond with scraping assemblies mounted thereon for preventing a direct contact of scraping assemblies with bottom of pond, and a transmission assembly 40 (not shown) for providing a drive source of the reciprocating motion of scraping assemblies.

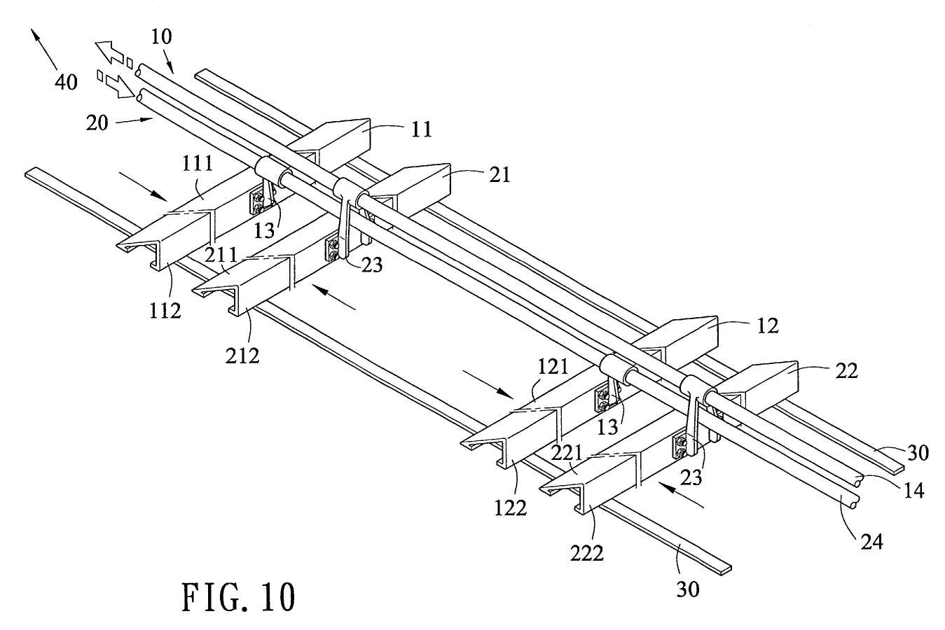

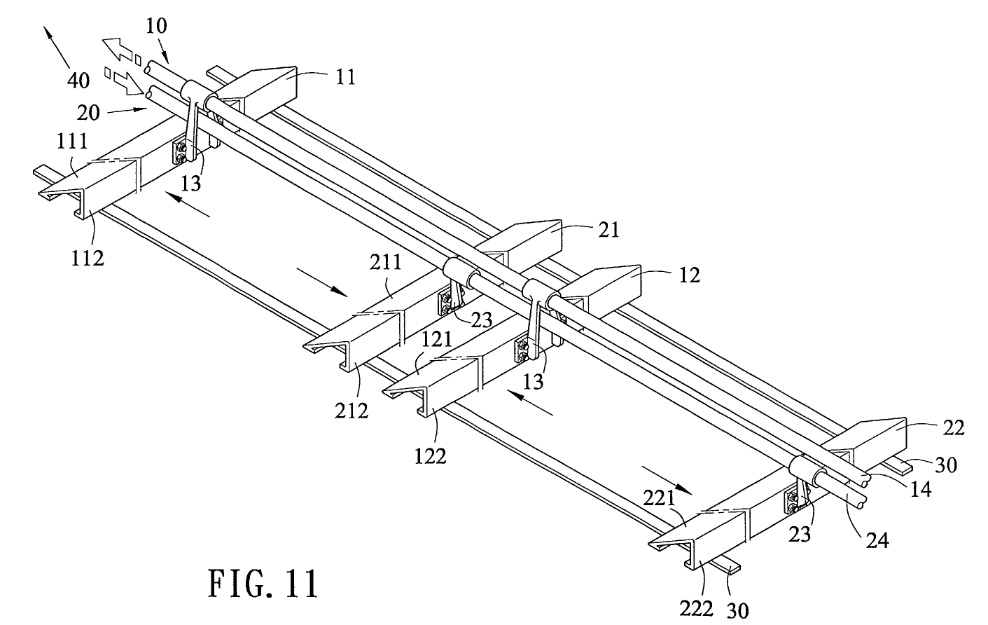

In one phase of a cycle of movement, first shaft 14 moves forward and second shaft 24 moves backward as transmission assembly 40 is activated. Hence, first scraping assembly 10 moves forward and second scraping assembly 20 moves backward respectively. As a result, both scraping members 11 and 21 and scraping members 12 and 22 move toward each other simultaneously (FIG. 10). In an immediate next phase of the cycle of movement, first shaft 14 moves backward and second shaft 24 moves forward respectively. Hence, first scraping assembly 10 moves backward and second scraping assembly 20 moves forward respectively. As a result, both scraping members 11 and 21 and scraping members 12 and 22 move away from each other while scraping members 21 and 12 move toward each other simultaneously (FIG. 11). As a result, mud/sediment is effectively pushed forward to a desired position by above reciprocating motion of scraping assemblies as transmission assembly 40 is activated.

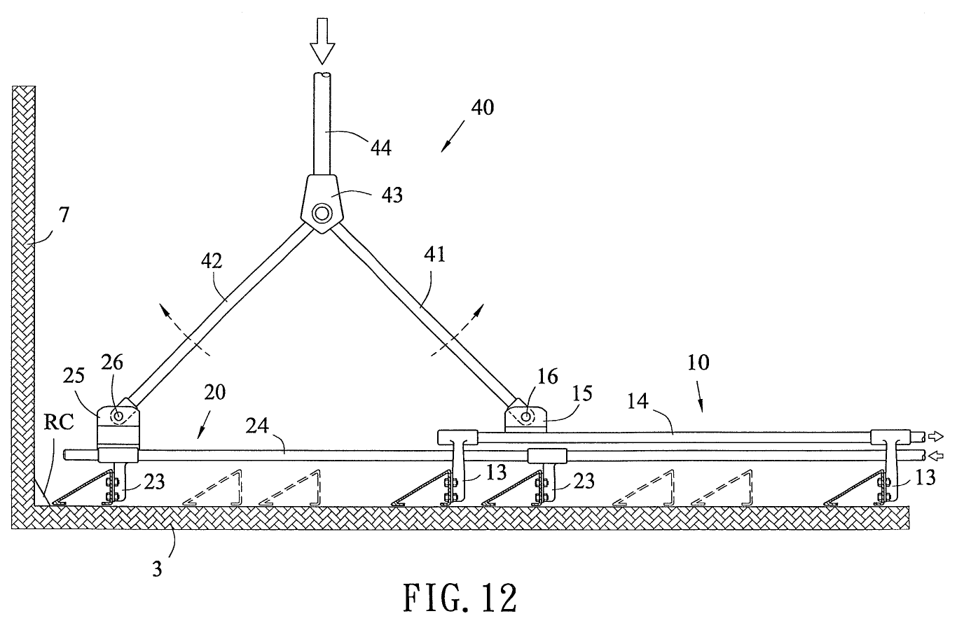

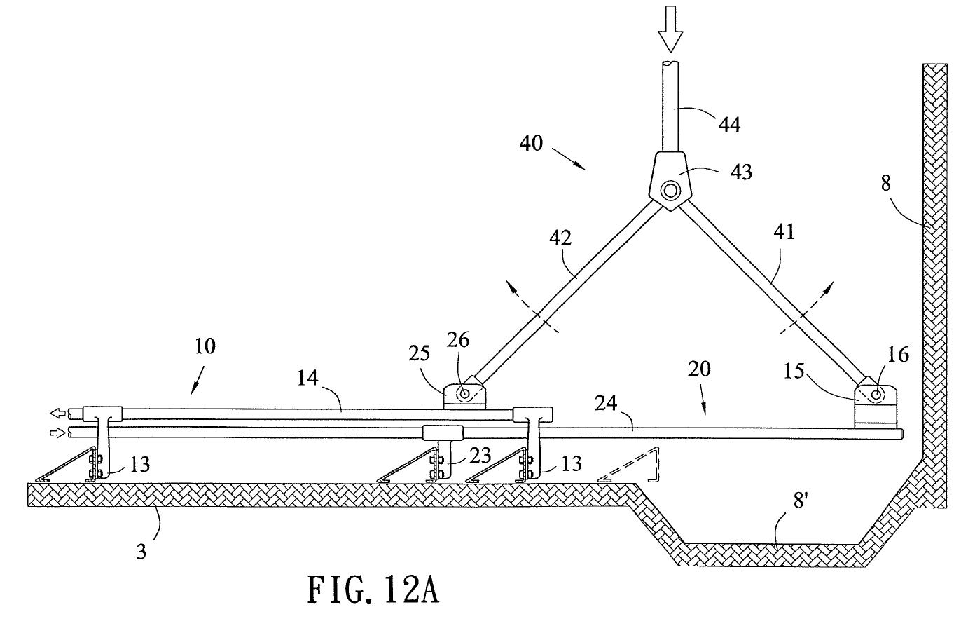

Referring to FIG. 12, there is shown transmission assembly 40 installed at a rear end of pond. Transmission assembly 40 comprises links 41, 42 and 44, and a pivot 43 for coupling links 41, 42 and 44 together to shape like an inverted-Y. Also, a wedge RC is formed at a corner between wall 7 and bottom 3 of pond. End of link 41 is coupled to connecting member 15 of first shaft 14 at pin 16 so as to transmit power of transmission assembly 40 to first scraping assembly 10. Similarly, end of link 42 is coupled to connecting member 25 of second shaft 24 at pin 26 so as to transmit power of transmission assembly 40 to second scraping assembly 20. With this arrangement, each of scraping assemblies 10 and 20 may be driven to perform a reciprocating motion as link 44 moves up and down continuously.

Referring to FIG. 12A, there is shown transmission assembly 40 installed at a front end of pond (i.e., near front wall 8) in the other embodiment. Also, a pit 8′ is formed on bottom 3 of pond near front wall 8.

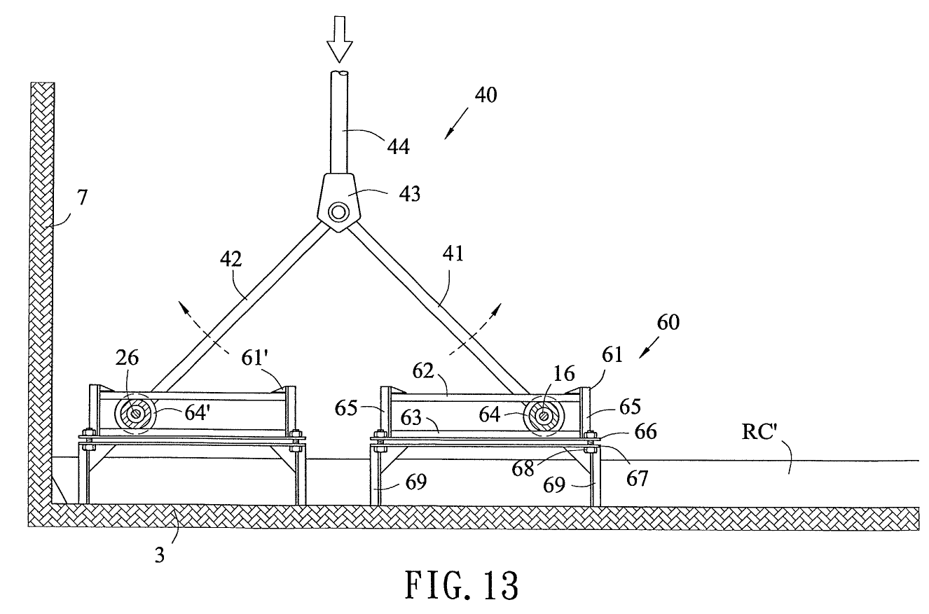

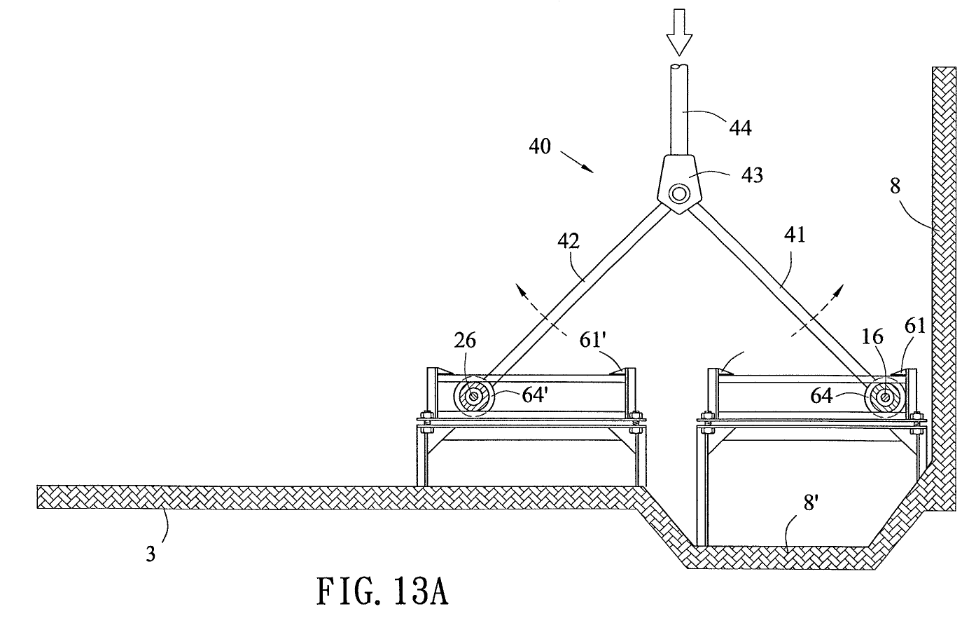

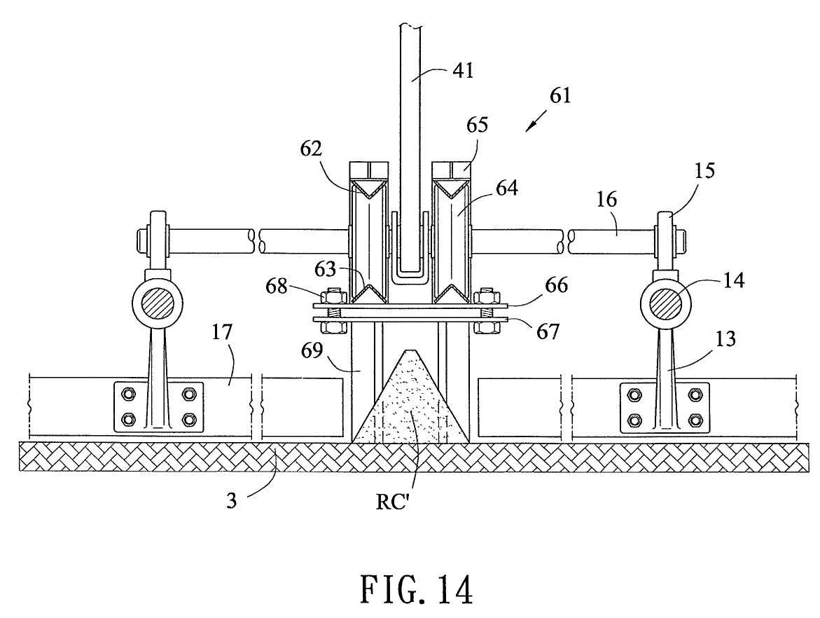

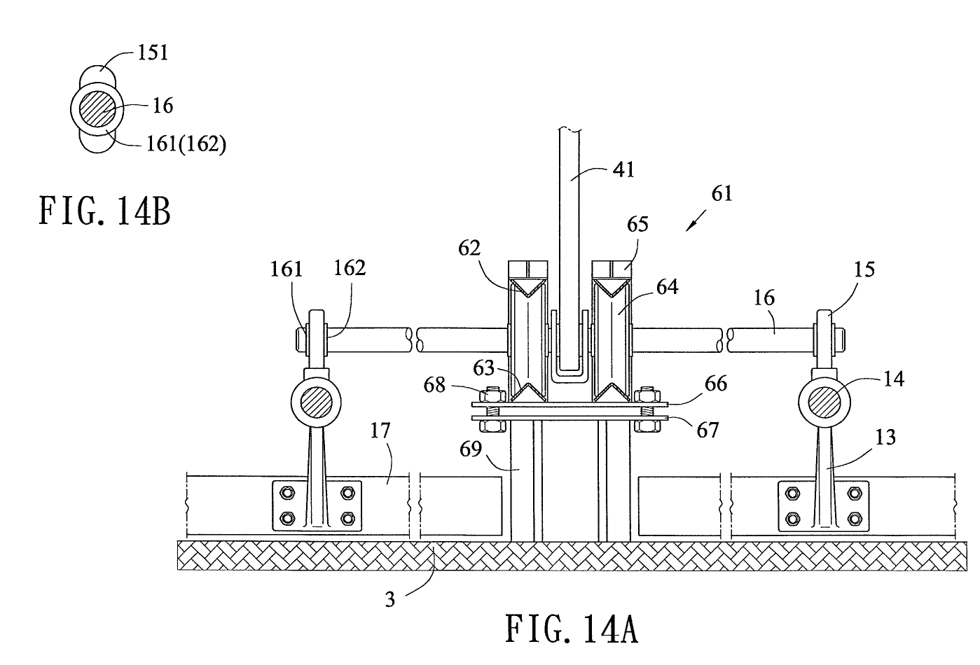

Referring to FIGS. 13 and 14, there is shown limiting assembly 60 installed at a rear end of pond. Limiting assembly 60 is provided to confine a movement of each of links 41 and 42 within a predetermined range. Also, force exerted on scraping assemblies 10 and 20 by a strong vertical movement of link 44 is buffered so as to protect scraping assemblies 10 and 20 in the reciprocating motion. Limiting assembly 60 comprises a pair of limiting sections 61 and 61′ wherein limiting section 61 comprises an upper rail 62, a lower rail 63 and a pulley 64 on pin 16 being activatable by link 41 wherein a moveable distance of pulley 64 confined by rails 62 and 63 is larger than the stroke in scraping sand. Limiting section 61 further comprises a frame 65, a seat 66 both for fixing rails 62 and 63, a plurality of posts 69 for supporting the limiting section 61 on bottom 3 of pond. Further, scraping plate 17 is arranged to maintain a sufficient gap with posts 69. Limiting section 61 further comprises an adjustment seat 67 and a plurality of adjustment bolts 68 for adjusting an EL (elevation) of rails 62 and 63 above bottom 3 of pond. Furthermore, a wedge RC′ is formed on bottom 3 of pond. Note that limiting section 61′ is a mirror image of limiting section 61. Thus a detailed description thereof is omitted herein except that pulley 64′ is provided on pin 26 being activatable by link 42.

Referring to FIGS. 13A and 14A, there is shown limiting assembly 60 installed at a front end (i.e., front wall 8) of pond.

Referring to FIG. 14B in conjunction with FIG. 14A, there are shown a connecting member 15 having an adjustment hole 151 and a pin 16 having two fittings 161 and 162 with connecting member 15 fastened therebetween. Also, connecting member 25 and pin 26 have the same constituent components as that of connecting member 15 and pin 16.

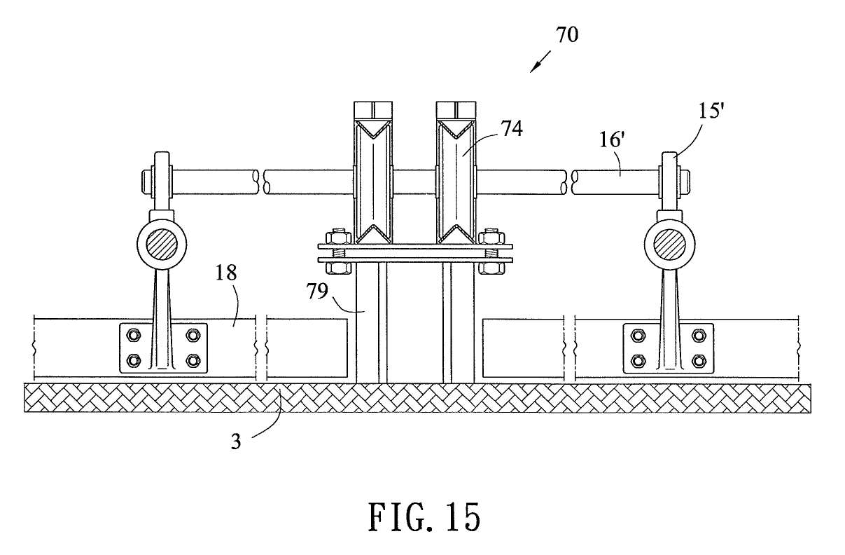

Referring to FIG. 15, there is shown a first preferred embodiment of rail assembly according to the invention. In the case that pond is elongate a rail assembly 70 is provided in pond or near front end of pond in connection with transmission assembly 40 shown in FIG. 14. As shown, first scraping assembly 10 comprises a connecting member 15′ and a pin 16′. Also, a limiting section 61 (not shown) is provided similar to that shown in FIG. 14. Further, a pulley 74 is provided on pin 16′. Furthermore, scraping plate 18 is arranged to maintain a sufficient gap with posts 69. Likewise, rail assembly 70 may be provided in pond or near rear end of pond in connection with transmission assembly 40 shown in FIG. 14A.

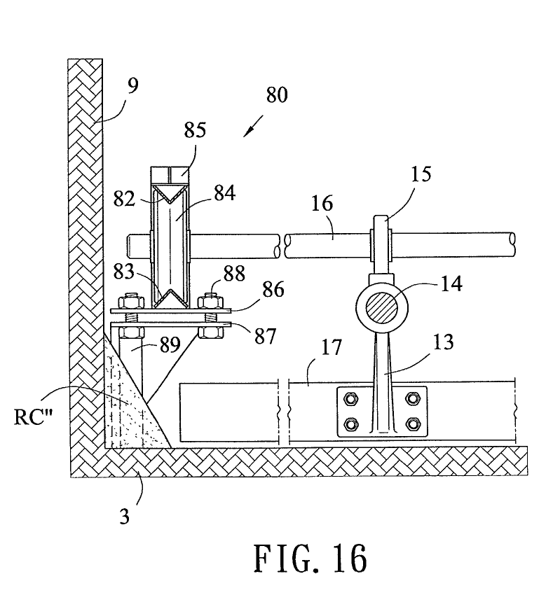

Referring to FIG. 16, there is shown a second preferred embodiment of rail assembly according to the invention. In the case that pond has a wider width a rail assembly 80 is provided near wall 9 of pond. First 80 comprises an upper rail 82, a lower rail 83 and a pulley 84 on a shaft extended from pin 16 wherein a moveable distance of pulley 84 confined by rails 82 and 83 is larger than the stroke in scraping sand. Rail assembly 80 further comprises a frame 85, a seat 86 both for fixing rails 82 and 83, a plurality of posts 89 for supporting the rail assembly 80 on bottom 3 of pond. Further, scraping plate 17 is arranged to maintain a sufficient gap with posts 89. Rail assembly 80 further comprises an adjustment seat 87 and a plurality of adjustment bolts 88 for adjusting an EL (elevation) of rails 82 and 83 above bottom 3 of pond. Furthermore, a wedge RC″ is formed on bottom 3 of pond.

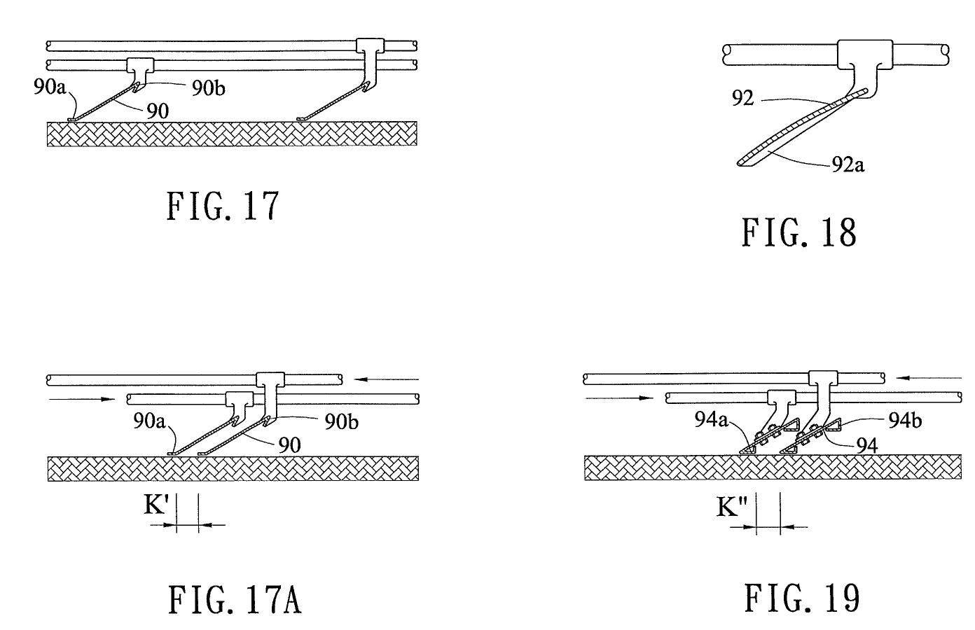

Referring to FIGS. 17 and 17A, there are shown a second preferred embodiment of scraping member 90 according to the invention and operation thereof respectively. Scraping member 90 has a bent lower end 90a for facilitating the act of scraping and a bent upper end 90b for enhancing a fastening strength to the connecting member. K′ is defined as a safe gap between two adjacent scraping members 90 belonging to different scraping assemblies for preventing contact from occurring in reciprocating motion of the scraper. Hence, a relation derived from equation 1 is represented by equation 2 below:

X+X+K′<S (2)

i.e., L+K′<S or L<S.

Referring to FIG. 18, there is shown a third preferred embodiment of scraping member 92 according to the invention wherein a plurality of ribs 92a are formed for enhancing structural strength.

Referring to FIG. 19, there is shown a fourth preferred embodiment of scraping member 94 according to the invention. Scraping member 94 has a triangular lower end 94a and a triangular upper end 94b. K″ is defined as a safe gap between two adjacent scraping members 90 belonging to different scraping assemblies for preventing contact from occurring in reciprocating motion of the scraper. Hence, a relation derived from equation 1 is represented by equation 3 below:

X+X+K″<S (3)

i.e., L+K″<S or L<S.

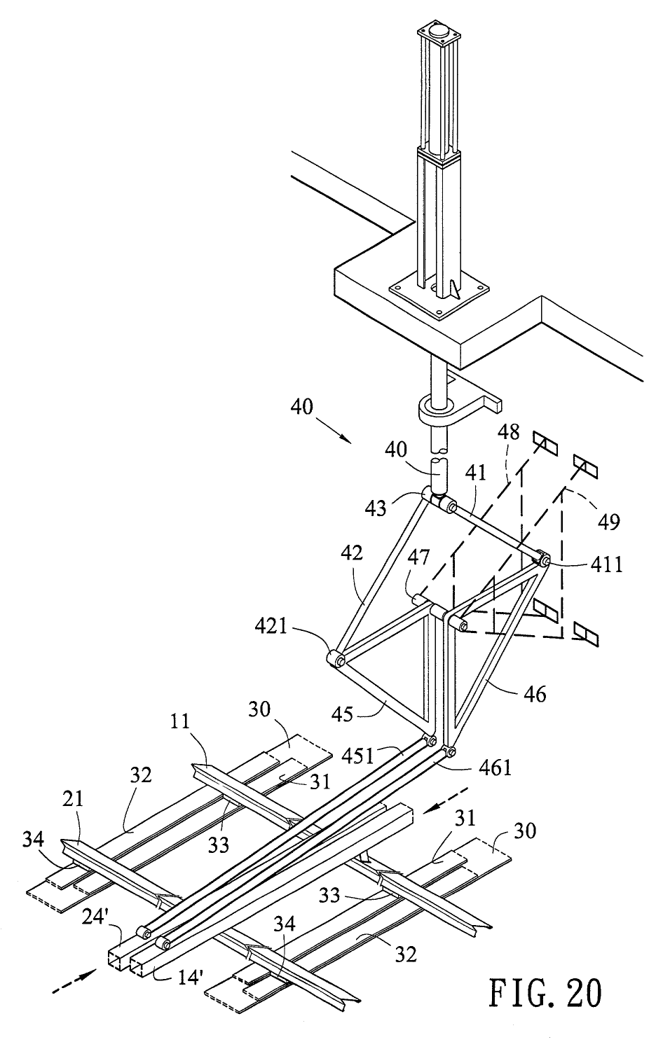

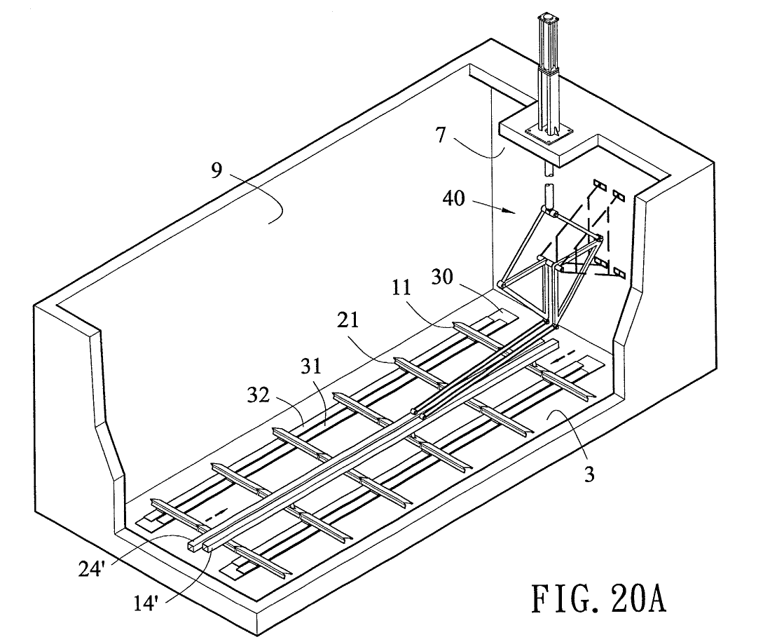

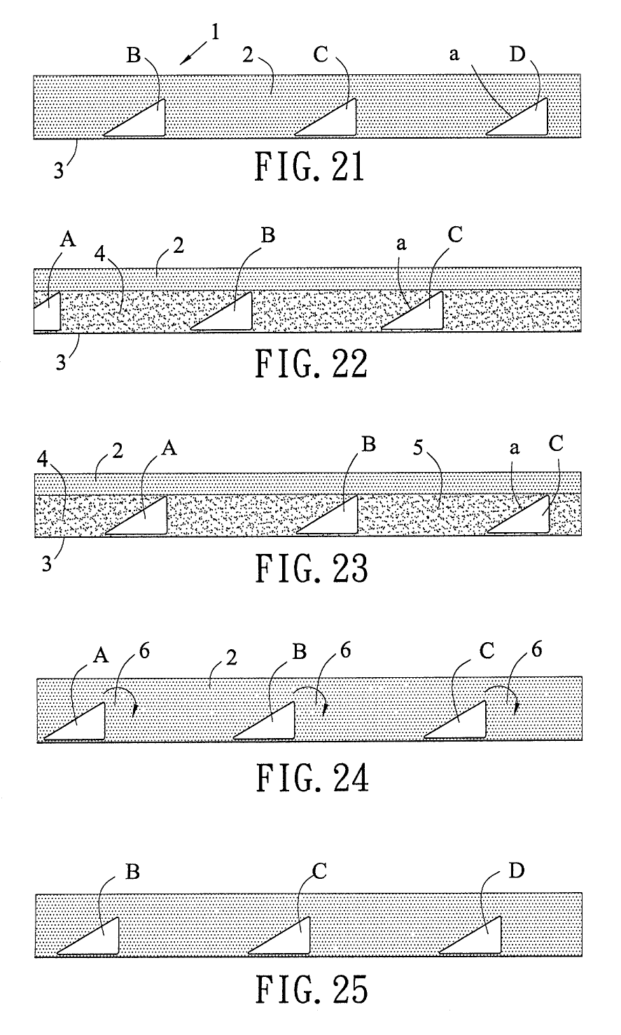

Referring to FIGS. 20 and 21, there are shown an exploded view of a second preferred embodiment of scraper according to the invention and a schematic perspective view of the scraper respectively. Transmission assembly 40 comprises a pair of links 41 and 42, link 44, a pair of triangular members 45 and 46, and a pair of brackets 48 and 49. A pivot 43′ is provided to couple links 41, 42 and 44 together to shape like an inverted-Y. Triangular member 45 has an upper acute angle end pivotably coupled to end 421 of link 42 and a lower acute angle end pivotably coupled to link 451 which is in turn pivotably coupled to second shaft 24′. Right angle end of triangular member 45 is pivotably coupled to a pin 47 which is in turn pivotably coupled to bracket 48. Similarly, triangular member 46 has an upper acute angle end pivotably coupled to end 411 of link 41 and a lower acute angle end pivotably coupled to link 461 which is in turn pivotably coupled to first shaft 14′. Right angle end of triangular member 46 is pivotably coupled to a pin 47 which is in turn pivotably coupled to bracket 49. With this configuration, a prismatic shaped linking assembly is formed by a pair of links 41 and 42 and a pair of triangular members 45 and 46. Also, with the provisions of links 451 and 461 first and second shafts 14′ and 24′ can perform a reciprocating motion as link 44 moves up and down continuously. Hence, mud/sediment can be effectively pushed forward to a desired position.

In addition, for facilitating a scraping of the invention two pairs of auxiliary rails 31 and 32 are provided on the pair of rail 30 on bottom of pond. Auxiliary rail 31 comprises a plurality of glides 33 each coupled to the scraping member (e.g., scraping member 11) of first scraping assembly so as to slide on inner side of rail 30 when the scraper is activated. Similarly, auxiliary rail 32 comprises a plurality of glides 34 each coupled to the scraping member (e.g., scraping member 21) of second scraping assembly so as to slide on outer side of rail 30 when the scraper is activated.

In brief, the invention can effectively remove mud/sediment from pond by a reciprocating motion.

While the invention herein disclosed has been described by means of specific embodiments, numerous modifications and variations could be made thereto by those skilled in the art without departing from the scope and spirit of the invention set forth in the claims.

What is claimed is:

1. A mud/sediment scraping method comprising:
arranging a plurality of parallel scraping members wherein the odd-numbered scraping members belonging to a first scraping assembly are alternate with the even-numbered scraping members belonging to a second scraping assembly;
defining a spacing between any two adjacent scraping members as S, a stroke of the scraping member of the first scraping assembly as L1, and a stroke of the scraping member of the second scraping assembly as L2 wherein relations of L1<<S and L2<<S hold; and
defining a gap between two adjacent scraping members belonging to different scraping assemblies as K for preventing contact from occurring in reciprocating motions of the scraping assemblies wherein the scraping assemblies move toward each other at a first phase of a cycle of the reciprocating motions thereof, move away from each other at a next second phase of the cycle of the reciprocating motions thereof, and move toward each other at a next third phase of the cycle of the reciprocating motions thereof during mud/sediment scraping.

2. The method of claim 1, wherein a value of the gap K is selected from a plurality of reference values.

3. The method of claim 1, wherein L1 is equal to L2.

4. The method of claim 1, wherein L1 is not equal to L2.

5. A mud/sediment scraping apparatus comprising:
a first scraping assembly including a plurality of scraping members, a plurality of first connecting members, and a plurality of first shafts wherein each scraping member is activatable by operating the first connecting member and the first shaft;
a second scraping assembly including a plurality of scraping members, a plurality of second connecting members, and a plurality of second shafts wherein each scraping member is activatable by operating the second connecting member and the second shaft; and
a transmission assembly for driving the scraping assemblies;
wherein the scraping assemblies move toward each other at a first phase of a cycle of the reciprocating motions thereof, move away from each other at a next second phase of the cycle of the reciprocating motions thereof, and move toward each other at a next third phase of the cycle of the reciprocating motions thereof in scraping mud/sediment settled on a bottom of a pond.

6. The apparatus of claim 5, wherein a spacing between any two adjacent scraping members is the same.

7. The apparatus of claim 5, wherein each scraping member has a scraping side and a pushing side.

8. The apparatus of claim 5, wherein each scraping member has a bent lower end and a bent upper end.

9. The apparatus of claim 5, wherein each scraping member has a plurality of ribs for enhancing a structural strength thereof.

10. The apparatus of claim 5, wherein each scraping member has a triangular lower end and a triangular upper end.

11. The apparatus of claim 5, wherein the transmission assembly is provided near either a front end or a rear end of the pond.

12. The apparatus of claim 5, wherein the transmission assembly comprises first, second, and third links, a pivot for coupling the links together to shape like an inverted-Y, a first pin, and a second pin whereby an end of the first link is coupled to the connecting member associated with the first shaft at the first pin, and an end of the second link is coupled to the connecting member associated with the second shaft at the second pin.

13. The apparatus of claim 5, further comprising a limiting assembly for confining a movement of each of the first and the second links within a predetermined range, the limiting assembly being associated with the transmission assembly, and the limiting assembly comprising:
a first limiting section comprising an upper rail, a lower rail, a pulley on the first pin being activatable by the first link wherein a moveable distance of the pulley is confined by the rails, a frame, a seat both for fixing the rails, a plurality of posts for supporting the limiting section on the bottom of the pond, and a scraping plate for maintaining a sufficient gap with the posts; and
a second limiting section comprising an upper rail, a lower rail, a pulley on the second pin being activatable by the second link wherein a moveable distance of the pulley is confined by the rails, a frame, a seat both for fixing the rails, a plurality of posts for supporting the limiting section on the bottom of the pond, and a scraping plate for maintaining a sufficient gap with the posts.

14. The apparatus of claim 13, wherein the first limiting section further comprises an adjustment seat and a plurality of adjustment bolts for adjusting an EL (elevation) of the rails thereof.

15. The apparatus of claim 13, wherein the connecting member has an adjustment hole and the first pin has two fittings with the connecting member fastened therebetween.

16. The apparatus of claim 5, further comprising a first rail assembly associated with the limiting assembly, the first rail assembly being located in the pond or near the front or the rear end of the pond, and the first rail assembly comprising an upper rail, a lower rail, a pulley on a third pin being activatable by the second link wherein a moveable distance of the pulley is confined by the rails, a frame, a seat both for fixing the rails, a plurality of posts for supporting the limiting section on the bottom of the pond, and a scraping plate for maintaining a sufficient gap with the posts.

17. The apparatus of claim 5, wherein a second rail assembly associated with the limiting assembly and the first rail assembly, the second rail assembly being located near a side wall of the pond, and the second rail assembly comprising an upper rail, a lower rail, a pulley on a shaft extended from the first pin wherein a moveable distance of the pulley is confined by the rails, a frame, a seat both for fixing the rails, a plurality of posts for supporting the second rail assembly on the bottom of the pond, and a scraping plate for maintaining a sufficient gap with the posts.

18. The apparatus of claim 17, wherein the second rail assembly further comprises an adjustment seat and a plurality of adjustment bolts for adjusting an EL of the rails thereof.

19. The apparatus of claim 5, wherein the transmission assembly further comprises first, second, and third linking element, first and second triangular members, first and second brackets, and a pivoting element for couple the linking elements together to shape like an inverted-Y wherein the first triangular member has an upper acute angle end pivotably coupled to an end of the second linking element, a lower acute angle end pivotably coupled to a fourth linking element which is in turn pivotably coupled to the second shaft, and a right angle end pivotably coupled to a fourth pin which is in turn pivotably coupled to the first bracket; and the second triangular member has an upper acute angle end pivotably coupled to an end of the first linking element, a lower acute angle end pivotably coupled to a fifth linking element which is in turn pivotably coupled to the first shaft, and a right angle end pivotably coupled to a fourth pin which is in turn pivotably coupled to the second bracket so that a prismatic shaped linking assembly is formed by the first and the second linking elements and the triangular members, and with the fourth and the fifth linking elements the first and second shafts are capable of performing the reciprocating motion as the third linking element moves up and down continuously in scraping mud/sediment settled on the bottom of the pond.

20. The apparatus of claim 5, further comprising two pairs of auxiliary rails on the first rail assembly on the bottom of the pond wherein one pair of the auxiliary rail comprises a plurality of glides each coupled to the scraping member of the first scraping assembly so as to slide on an inner side of the first rail assembly when the apparatus is activated, and the other pair of the auxiliary rail comprises a plurality of glides each coupled to the scraping member of the second scraping assembly so as to slide on an outer side of the second rail assembly when the apparatus is activated so as to facilitate the mud/sediment scraping.
